(19) United States
(12) Patent Application Publication
(10) Pub. No.: US 2024/0171221 A1
(43) Pub. Date: May 23, 2024

(54) FILTER MANAGEMENT PROCEDURE FOR RECONFIGURABLE RELAYING DEVICES USING POLARIZATION MULTIPLEXING OF DATA SIGNALS AND REFERENCE SIGNALS

(71) Applicant: Sony Group Corporation, Tokyo (JP)

(72) Inventors: Erik BENGTSSON, Eslöv (SE); Fredrik RUSEK, Eslöv (SE); Jose FLORDELIS, Lund (SE); Olof ZANDER, Södra Sandby (SE); Kun ZHAO, Malmö (SE)

(21) Appl. No.: 18/281,726

(22) PCT Filed: Mar. 25, 2022
(86) PCT No.: PCT/EP2022/057922

§ 371 Date: Sep. 12, 2023

(30) Foreign Application Priority Data
Mar. 26, 2021 (SE) 2150365-1

(51) Int. Cl. H04B 7/04; H04B 7/06

(52) U.S. Cl. CPC H04B 7/04013; H04B 7/06952

(57) ABSTRACT

First signals and second signals are communicated using polarization multiplexing. Different spatial filters are applied at a reconfigurable relaying device for the first and second signals.

### TECHNICAL FIELD

Various examples of the disclosure generally relate to reconfigurable relaying devices used to facilitate a communication between two communication nodes. Various examples of the disclosure specifically relate to a filter management procedure to select appropriate spatial filters at the RRD for supporting the communication.

### BACKGROUND

To increase a coverage area for wireless communication, it is envisioned to use reconfigurable relaying devices (RRD) to communicate with wireless communication devices (UEs).

RRDs are also sometimes referred to as large intelligent surface (LIS). See, e.g., Sha Hu, Fredrik Rusek, and Ove Edfors. “Beyond massive MIMO: The potential of data transmission with large intelligent surfaces.” IEEE Transactions on Signal Processing 66.10 (2018): 2746-2758. RRDs are also sometimes referred to as reconfigurable intelligent surfaces (RISs). In its most general sense, this concept includes both reflective surfaces reflecting incident electromagnetic waves, as well as transmissive surfaces, which refer to surfaces that let incident waves pass through them but can control the angle of the outgoing signals. It is conceivable that transmissive surfaces can change the amplitude of the signals passing through it by reducing it. For example, they can be configured to not let through any signal (amplitude=0).

The RRD can be implemented by an array of antennas that reflect incident electromagnetic waves/signals. The array of antennas can be passive, i.e., the array of antennas may not be able to change amplitude let alone provide amplification; but may provide a variable phase shift. The incident signals are reflected. An input spatial direction from which incident signals on a data carrier are accepted and an output spatial direction into which the incident signals are reflected can be reconfigured, by changing a phase relationship between the antennas. This is defined by a respective spatial domain (transmission/reception) filter (or, simply, spatial filter hereinafter). In some scenarios, also the amplitude of the outgoing signals can be adjusted with respect to the amplitude of the incident signals. A variable gain can be set. This is referred to relaying.

The UE can exhibit mobility: The UE can move with respect to the RRD. Then, to select the appropriate spatial filter selecting a spatial channel of good quality (e.g., low path loss, low signal fade, etc.), a filter management procedure (FMP) can be used. The RRD and other communication nodes participate in the FMP.

### SUMMARY

Accordingly, there is a need for advanced techniques of operating an RRD. In particular, there is a need for facilitating a filter management procedure.

This need is met by the features of the independent claims. The features of the dependent claims define examples.

According to an example, a method of operating a RRD is provided. The RRD is reconfigurable to provide multiple spatial filters. Each one of the multiple spatial filters is associated with the respective input spatial direction from which incident signals are accepted, as well as with a respective output spatial direction into which the incident signals are output. The RRD supports communication between a first communication node and a second communication node. The method includes configuring a first spatial filter to forward one or more first signals using a first polarization into a first output spatial direction. The method also includes, contemporaneously to said configuring of the first spatial filter: configuring one or more second spatial filters to forward one or more second signals using a second polarization into one or more second output spatial directions. The one or more second output spatial directions are at least partially different than the first output spatial direction.

A wireless communication device executing such method is further provided.

A computer program or a computer program product or a computer-readable storage medium includes program code. The program code can be loaded and executed by at least one processor. Upon loading and executing the program code, the at least one processor performs a method of operating an RRD. The RRDs reconfigurable to provide multiple spatial filters. Each one of the multiple spatial filters is associated with the respective input spatial direction from which incident signals are accepted, as well as with a respective output spatial direction into which the incident signals are output. The RRD supports communication between a first communication node and a second communication node. The method includes configuring a first spatial filter to forward one or more first signals using a first polarization into a first output spatial direction. The method also includes, contemporaneously to said configuring of the first spatial filter: configuring one or more second spatial filters to forward one or more second signals using a second polarization into one or more second output spatial directions. The one or more second output spatial directions are at least partially different than the first output spatial direction.

A method of operating a first communication node is provided. The first communication node communicates with a second communication node via a RRD. The RRD is reconfigurable to provide multiple spatial filters. Each one of the multiple spatial filters is associated with the respective input spatial direction from which incident signals are accepted and with a respective output spatial direction into which the incident signals are output. The method includes transmitting, towards the RRD, one or more first signals using a first polarization. The method also includes transmitting, towards the RRD, one or more second signals using a second polarization that is different than the first polarization. The one or more first signals and the one or more second signals are transmitted using polarization multiplexing.

A first communication node is provided. The first communication node comprises a processor. The processor can perform such method.

A computer program or a computer program product or a computer-readable storage medium includes program code. The program code can be loaded and executed by at least one processor. Upon loading and executing the program code, the at least one processor performs a method of operating a first communication node. The first communication node communicates with a second communication node via an RRD. The RRD is reconfigurable to provide multiple spatial filters. Each 1 of the multiple spatial filters is associated with the respective input spatial direction from which incident signals are accepted and with a respective output spatial direction into which the incident signals are output. The method includes transmitting, towards the RRD, one or more first signals using a first polarization. The method also includes transmitting, towards the RRD, one or more second signals using a second polarization that is different than the first polarization. The one or more first signals and the one or more second signals are transmitted using polarization multiplexing.

A method of operating a second communication node is provided. The second communication node communicates with a first communication node via an RRD. The RRD is reconfigurable to provide multiple spatial filters. Each one of the multiple spatial filters is associated with the respective input spatial direction from which incident signals are accepted, as well as with the respective output spatial direction into which the incident signals are output. The method includes receiving, via the RRD, one or more first signals using a first polarization. The method also includes, receiving via the RRD, using one or more second signals using a second polarization. The second polarization is different than the first polarization. The one or more first signals and the one or more second signals are received using polarization multiplexing.

A second communication node is provided. The second communication node comprises a processor. The processor can perform such method.

A computer program or a computer program product or a computer-readable storage medium includes program code. The program code can be loaded and executed by at least one processor. Upon loading and executing the program code, the at least one processor performs a method of operating a second communication node. The second communication node communicates with a first communication node via an RRD. The RRD is reconfigurable to provide multiple spatial filters. Each one of the multiple spatial filters is associated with the respective input spatial direction from which incident signals are accepted, as well as with the respective output spatial direction into which the incident signals are output. The method includes receiving, via the RRD, one or more first signals using a first polarization. The method also includes, receiving via the RRD, using one or more second signals using a second polarization. The second polarization is different than the first polarization. The one or more first signals and the one or more second signals are received using polarization multiplexing.

It would be possible that the one or more first signals include data signals of a data transmission. The one or more first signals can include reference signals (RSs).

The one or more second signals may include reference signals. For instance, these reference signals could be of a filter management procedure associated with a data transmission for which data signals are forwarded using the first spatial filter.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a communication system including a base station and a UE according to various examples.

FIG. 2 schematically illustrates details of the communication system according to FIG. 1.

FIG. 3 schematically illustrates communication between a base station and a UE via an RRD according to various examples.

FIG. 4 schematically illustrates details of the RRD according to various examples.

FIG. 5 schematically illustrates multiple spatial filters of the RRD for forwarding signals having different polarizations according to various examples.

FIG. 6 schematically illustrates multiple spatial filters of the RRD for forwarding signals having different polarizations according to various examples.

FIG. 7 is a flowchart of a method according to various examples.

FIG. 8 is a flowchart of a method according to various examples.

FIG. 9 is a flowchart of a method according to various examples.

FIG. 10 is a flowchart of a method according to various examples.

FIG. 11 is a flowchart of a method according to various examples.

FIG. 12 is a signaling diagram of communication between the base station, a UE, and an RRD according to various examples.

### DETAILED DESCRIPTION OF EXAMPLES

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between communication nodes (CNs; hereinafter, simply node). In some examples, the wireless communication system can be implemented by a wireless communication network, e.g., a radio-access network (RAN) of a Third Generation Partnership Project (3GPP)-specified cellular network (NW). In such case, the nodes can be implemented by an access node such as a base station (BS) of the RAN and by wireless communication devices (also referred to as user equipment, UE).

A communication between a BS and a UE can include communicating data from the BS to the UE (downlink, DL) and from the UE to the BS (uplink, UL). Also, sidelink (SL) communication between two UEs would be possible.

According to various examples, it is possible to use multi-antenna techniques. Multi-antenna techniques are used to enhance reliability and/or throughput of wireless communication. The BS may use multiple antennas. Thereby, a signal (or data stream, or layer) can be transmitted redundantly (diversity multi-antenna mode) along multiple paths or multiple signals (or multiple data streams, or multiple layers) can be transmitted on multiple paths (spatial multiplexing multi-antenna operational mode). Here, the term “path” can define an outgoing spatial direction for transmitting or an incoming spatial direction for reception.

It is possible also to use beamforming: here, each path can be utilized by focusing the transmission energy for transmitting (transmit beam, TX beam) and/or the receive sensitivity for receiving (receive beam, RX beam) to a particular geometrical direction as seen from a certain node. It would also be possible to define a respective focal length, i.e., focus the transmission energy and/or receive sensitivity with respect to a certain point arranged at a given direction and distance. For beamforming, the process of identifying the appropriate beams is often referred to as beam management.

Signals can be communicated using a certain polarization. As a general rule, linear polarizations or circular polarizations could be used. Two orthogonal polarizations can be used to increase the number of layers by a factor of 2. Also, two polarizations can be used for increasing diversity. The two polarizations can—without loss of generality—be simply referred to as horizontal and vertical (H-POL and V-POL, respectively).

According to examples, a first node can communicate with at least a second node via an RRD. This could pertain to UL communication, DL communication, or sidelink communication. To forward an incident signal, the RRD may not decode the signal. The RRD may not translate an incident signal into the baseband. Rather, a reflection or, if possible, amplification of the RF signals can be used. Variable phase changes across the RRD can be applied. This enables to steer the outgoing signals appropriately. This is explained in further detail below.

As a general rule, the RRD is configured to employ multi-antenna techniques. In particular, the RRD is reconfigurable to provide multiple spatial filters; different spatial filters can be applied at different points in time. Thereby, electromagnetic waves can be diverted. Each one of the multiple spatial filters is associated with a respective input spatial direction from which incident signals on a respective data radio carrier are accepted, as well as with a respective output spatial direction into which incident signals are reflected or amplified by the RRD. Each output spatial direction is associated with a respective beam, e.g., having a respective output spatial direction, a beam width, etc. The RRD may comprise a plurality of reflective elements (REs), in particular polarized REs. Each spatial filter is achieved by applying a certain phase shift onto the incident electromagnetic waves, at each respective RE. The RRD thereby implements beamforming.

The RRD may include one or more antenna arrays. The RRD may include a meta-material surface. In examples, an RRD may include a reflective antenna array (RAA).

For example, the REs could be implemented by mechanically actuatable antennas or reflective mini-surfaces. Liquid crystals could be used.

In the case the RRD is implemented as a meta-material, individual unit cells of the meta material—that may be implemented by REs—of the RRD, i.e., repetitive tunable structures, may be non-resonant. These unit cells may be significantly smaller than a wavelength of the electromagnetic wave to be reflected. The unit cells may be jointly tuned to achieve the desired reflection properties of the RRD. The individual unit cells may be tuned differently to obtain the desired reflection properties of the RRD. The individual unit cells may not necessarily have to have the same properties in terms of phase shift, amplitude or polarization.

In the following, REs may refer to as antenna elements and/or unit cells. The term polarized REs may relate to the REs being able to individually and/or collectively influence the polarization of the reflected electromagnetic wave.

For example, an RRD may include an RAA including horizontally and vertically polarized antennas that reflect incident signals originating from a transmitter node from a same directive angle, the incident signals having polarizations aligned to the polarizations of the polarized antennas. The orthogonality between the incident signals of different polarization is maintained and can be independently decoded at the receiver node.

As the antenna elements are assumed to support independent configurations for the two polarizations, different spatial filters may be configured, to reflect the incident signals of the different polarizations in different directions. Thus, two signals having H-POL and V-POL respectively can be forwarded separately, using different spatial filters, at the RRD. In other words, a spatial filter can be associated with a certain polarization, e.g., H-POL or V-POL. Accordingly, for different polarizations, different spatial filters can be configured. This means that differently polarized signals can be output to different output spatial directions.

Next, details with respect to the control of the RRD are explained.

There are many schools-of-thought for how RRDs should be integrated into 3GPP-standardized RANs.

In an exemplary case, the NW operator has deployed the RRDs and is therefore in full control of the RRD operations. The UEs, on the other hand, may not be aware of the presence of any RRD, at least initially, i.e., it is transparent to a UE whether it communicates directly with the BS or via an RRD. The RRD essentially functions as a coverageextender of the BS. The BS may have established a control link with the RRD.

According to another exemplary case, it might be a private user or some public entity that deploys the RRD. Further, it may be that the UE, in this case, controls RRD operations. The BS, on the other hand, may not be aware of the presence of any RRD and, moreover, may not have control over it/them whatsoever. The UE may gain awareness of the presence of RRD by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the RRD. Ultrawideband communication can be used. It would be possible to use an in-band signaling protocol.

In the following it may be assumed that the first node is configured for controlling the RRD. In some examples, the first node may thus correspond to the BS and in other examples the first node may correspond to the UE.

Various techniques are concerned with facilitating an FMP for selecting and configuring the appropriate spatial filter at the RRD. The FMP may be associated with a data transmission between the first node and the second node. This means that the FMP facilitates configuring one or more spatial filters at the RRD to forward data signals of the data transmission so that they reach the intended recipient. The FMP can be referred to as beam management at the RRD. The FMP, however, can involve tasks not only at the RRD, but also at the first node and the second node.

As a general rule, multiple nodes may participate in the FMP. For example, the RRD can participate in the FMP, as well as the first node and/or the second node.

For example, the FMP may include communicating reference signals (RSs) between the first node and the second node via the RRD. The first node may transmit the RSs and the second node may receive the RSs, and/or vice versa.

As a general rule, various implementations of RSs are possible. Examples include Sounding reference signals (SRS), channel state information RS (CSI-RS), demodulation RS (DMRS), positioning RS (PRS), phase-tracking RS (PT-RS), remote interference management RS (RIM-RS), Synchronization Signal Blocks (SSBs). See 3GPP TS 38.211, Version 16.4.0, 2021-01-08.

As a general rule, an RS has a well-defined signal shape and signal properties, e.g., transmit amplitude and transmit phase. By comparing a receive property with the a-priori known transmit property, it is possible to conclude on the channel acting on the RS. The quality of communicating can be benchmarked. For example, an error rate could be predicted. Other quality metrics could be assessed. The RRD influences the channel acting on the RSs. Thereby, it is possible to infer information regarding the appropriate spatial filter to be used by the RRD to act on the RSs, to tailor the channel. In other words, the performance of the different spatial filters at the RRD can be sounded. An appropriate spatial filter at the RRD can be configured by comparing one or more receive properties—e.g., phase shift and/or amplitude— of the RSs communicated using different spatial filters. RSs are different than data signals of a data transmission in that RSs do not encode higher-layer data, e.g., Layer 3 control messages or payload data or Layer 2 control signaling, etc. However, data signals may rely on RSs, e.g., CSI-RS and DMRS, for proper demodulation. Accordingly, sometimes the term “data” includes both data signals and the associated RSs.

Various techniques are based on the finding that the FMP can be dependent on the actual hardware implementation of the RRD. It has been found that various FMP are not suitable for low-cost implementations of the RRD, e.g., using simple and/or slow REs. To enable low-cost simple implementations, analogue or even mechanical beamforming with a strong limitation on the number of simultaneous spatial filters may be implemented at the RRD. RAAs can be used. For an RAA, the spatial filtering basically controls the direction of an outgoing reflected signal, without any signal processing nor amplification. Such low-cost implementations significantly limit options for the FMP.

Techniques are disclosed which enable an efficient FMP at the RRD, even for scenarios in which the RRD is implemented using an RAA using analogue beamforming.

According to various examples, RSs of the FMP and data signals can be multiplexed in the polarization domain. This means that RSs and data signals can be contemporaneously transmitted.

On the one hand, this facilitates a low-latency data transmission: The communication of data signals need not be interrupted for communicating RSs. On the other hand, the FMP can be implemented by communicating the RSs. Thereby, in turn, the appropriate spatial filter can be configured at the RRD to facilitate the data transmission. For example, the UE mobility can be tracked at a high sampling rate, by often implementing the FMP and communicating RSs often.

By allocating the data signals to one polarization, while the orthogonal polarization is used for probing of other directions using the RSs, feedback on alternative spatial filters to be configured at the RRD can be obtained. The first node and the second node can be aware of the configuration associated with said communicating of the RSs and can align their polarization-configurations to that of the RRD.

This enables the node to simultaneously have a serving spatial filter to communicate the data signals and further spatial filters that are, e.g., swept, to try alternative spatial directions for the purpose of UE mobility. The latency of the data transmission can be kept low.

For example, the following sequence of steps can implement the FMP. The purpose of the FMP is to check whether the spatial filter used at the RRD to forward data signals of a data transmission needs to be reconfigured.

TABLE 1
Various steps associated with an FMP to support a data transmission by configuring
a spatial filter or spatial filters for forwarding data signals of the data
transmission at an RRD, wherein a UE, a BS and the RRD participate in the FMP.
While in TAB. 1 a scenario has been explained in which the signals - i.e., data
signals and RSs - are transmitted in the DL, the signaling can alternatively
or additionally be in UL or along the sidelink. Then the UE transmits one or
more data signals and one or more RSs in a polarization multiplexed manner.

| Step | Explanation |
|---|---|
| I | Two signals, intended for a single UE, are contemporaneously transmitted |
| | from a BS. The first signal is a data signal of the data transmission, i.e., a |
| | signal encoding a control message on a control channel such as the Physical |
| | Downlink Control Channel (PDCCH), or a signal encoding a control message |
| | or payload data of a shared channel such as the Physical Downlink Shared |
| | Channel (PDSCH). The second signal is an RS that may, e.g., be used for |
| | sounding the channel between the BS and the UE. |
| | In detail: The BS transmits one or more data signals on time-frequency resources |
| | and using a first polarization in a TX beam toward the RRD. The first |
| | polarization of the one or more data signals is aligned with a first polarization |
| | of the RRD. The BS transmits on the same time/frequency resources the one |
| | or more RSs using a second polarization aligned with a second polarization |
| | of the RRD, using the same TX beam also used for the one or more data signals. |
| | This corresponds to the data signal and the RS being transmitted using |
| | polarization multiplexing. |
| II | The RRD is configured to forward the one or more data signals having the |
| | first polarization in a first angle, toward a UE, and the one or more RSs having |
| | the second polarization in a different angle (possibly adjacent to the first |
| | beam angle). Different spatial filters are used for the first polarization and the |
| | second polarization; these different spatial filters are contemporaneously |
| | configured. |
| | The one or more RSs can be forwarded using multiple different spatial filters |
| | that can be swept. For a reference measurement, the same spatial filter as |
| | the spatial filter used for forwarding the one or more data signals may be |
| | used. |
| III | The UE is configured to receive the one or more data signals having the first |
| | polarization with a current UE RX beam, aligned to the first polarization of |
| | the RRD; the UE is also configured to monitor for the one or more RSs using |
| | the same UE RX beam, yet aligned to the second polarization of the RRD. |
| IV | The UE may optionally report an estimated property of the one or more RSs |
| | to the BS (feedback associated with the one or more RSs). The feedback |
| | can be provided using a control message, e.g., on the Physical Shared Uplink |
| | Channel (PUSCH); respective data signals can be transmitted on a current |
| | UL TX beam towards the BS, e.g., via the RRD. |
| V | Upon obtaining the feedback associated with the one or more RSs from the |
| | UE, the BS can then provide configuration information to the RRD to |
| | (re-)configure the spatial filter or spatial filters used for forwarding data |
| | signals of the data transmission based on the estimated property of the one or |
| | more RSs. A control link between the BS and the RRD can be used, e.g., via Wifi |
| | or Bluetooth or using in-band signaling. The RRD can then configure one or |
| | more spatial filters - e.g., for both the first and second polarization - to |
| | forward data signals of the data transmission. |

Such techniques enable robust mobility management for UEs served by RRDs by using one spatial filter—e.g., associated with V-POL, without loss of generality— for continuous communication of data signals of a data transmission while, at the same time, a further spatial filter—associated with H-POL, without loss of generality— can be swept.

This is in particular relevant for an RRD that does not support fast filter reconfiguration, hence with slow switching rate between different spatial filters (e.g., mechanically steerable, MEMS steerable, or Barium-Strontium Titanate (BST) electrically steerable, liquid crystal electrically steerable, etc.), or if real-time switching of the spatial filters is limited by the control interface itself (e.g. autonomous switching, dedicated non real-time interface).

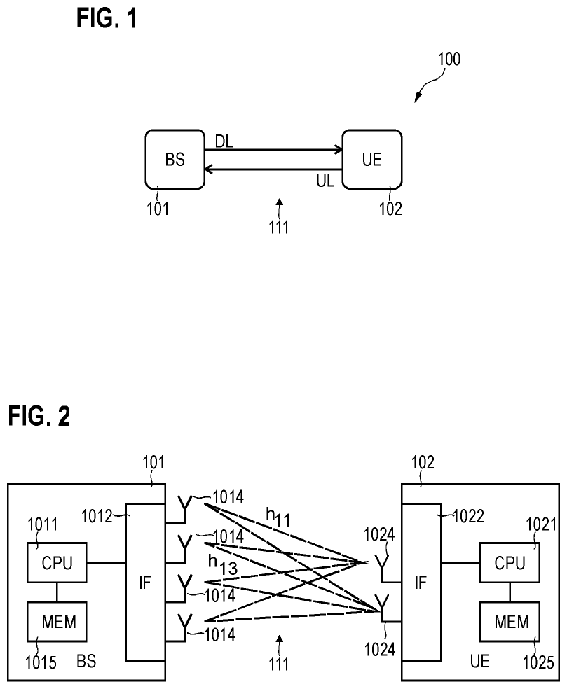

FIG. 1 schematically illustrates a communication system 100. The communication system includes two nodes 101, 102 that are configured to communicate with each other via a data carrier 111. In the example of FIG. 1, the node 101 is implemented by an access node, more specifically a BS, and the node 102 is implemented by a UE. The BS 101 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by a BS 101 of a cellular NW and a UE 102.

As illustrated in FIG. 1, there can be DL communication, as well as UL communication. Various examples described herein particularly focus on the DL communication from the BS 101 to the UE 102. However, similar techniques may be applied to UL communication from the UE 102 to the BS 101. Also, sidelink communication between peer nodes can be subject to the techniques described herein.

The UE 102 and the BS 101 can communicate on a data carrier 111. For instance, the data carrier 111 may have a carrier frequency of not less than 20 GHz or even not less than 40 GHz. The data carrier 111 may be via an RRD (not illustrated in FIG. 1).

FIG. 2 illustrates details with respect to the BS 101. The BS 101 implements an access node to a communications network, e.g., a 3GPP-specified cellular network. The BS 101 includes control circuitry that is implemented by a processor 1011 and a non-volatile memory 1015. The processor 1011 can load program code that is stored in the memory 1015. The processor 1011 can then execute the program code. Executing the program code causes the processor to perform techniques as described herein, e.g.: participating in an FMP associated with a data transmission between the BS 101 and the UE 102 (cf. TAB. 1); transmitting and/or receiving (communicating) data signals using a DL TX beam or an UL RX beam and having a first polarization, e.g., V-POL; communicating RSs having a second polarization, e.g., H-POL, using the same DL TX beam or UL RX beam as the data signals, or using different beams; monitoring for RSs using one or more UL RX beams; exchanging polarization information with an RRD, the polarization information being indicative of the first polarization and the second polarization (i.e., indicating the orientation of the polarization in a reference frame); communicating with the RRD on a control link; providing configuration information to the RRD for configuring a spatial filter at the RRD; activating or deactivating a channel sounding mode of the FMP at the RRD; communicating a timing of the channel sounding mode; etc.

FIG. 2 also illustrates details with respect to the UE 102. The UE 102 includes control circuitry that is implemented by a processor 1021 and a non-volatile memory 1025. The processor 1021 can load program code that is stored in the memory 1025. The processor can execute the program code. Executing the program code causes the processor to perform techniques as described herein, e.g.: participating in an FMP for configuring a spatial filter or spatial filters at an RRD, the FMP being associated with the data transmission between the BS 101 and the UE 102; communicating data signals and/or RS using an DL RX beam and/or an UL TX beam; attempting to receive (monitoring) for RSs using the same DL RX beam or another DL RX beam; providing feedback to the BS 101, the feedback being indicative of one or more receive properties of the RSs; etc.

FIG. 2 also illustrates details with respect to communication between the BS 101 and the UE 102 on the data carrier 111. The BS 101 includes an interface 1012 that can access and control multiple antennas 1014. Likewise, the UE 102 includes an interface 1022 that can access and control multiple antennas 1024.

While the scenario of FIG. 2 illustrates the antennas 1014 being coupled to the BS 101, as a general rule, it would be possible to employ transmit-receive points (TRPs) that are spaced apart from the BS.

The interfaces 1012, 1022 can each include one or more TX chains and one or more RX chains. For instance, such RX chains can include low noise amplifiers, analogue to digital converters, mixers, etc. Analogue and/or digital beamforming would be possible. Thereby, phase-coherent transmitting and/or receiving (communicating) can be implemented across the multiple antennas 1014, 1024. Multi-antenna techniques can be implemented.

By using a TX beam, the direction of signals transmitted by a transmitter of the communication system is controlled. Energy is focused into a respective direction or even multiple directions, by phase-coherent superposition of the individual signals originating from each antenna 1014, 1024. Thereby, a data stream can be directed. The data streams transmitted on multiple beams can be independent, resulting in spatial multiplexing multi-antenna transmission; or dependent on each other, e.g., redundant, resulting in diversity multi-input multi-output (MIMO) transmission.

Signals can be transmitted using one of H-POL and V-POL. Thereby, per TX beam, two independent or dependent data streams—having H-POL and V-POL—can be implemented.

As a general rule, alternatively or additionally to such TX beams, it is possible to employ RX beams. These RX beam can be selective to receive signals having H-POL or V-POL, respectively.

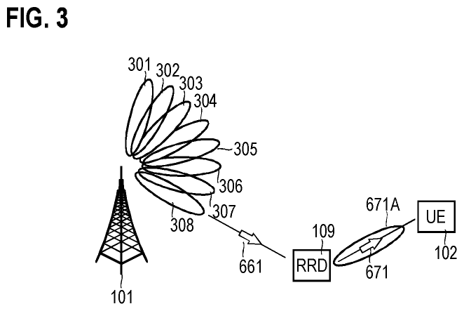

FIG. 3 illustrates aspects with respect to communicating via an RRD 109. The UE 102 is served by the BS 101 via an RRD 109.

The BS 101 uses a DL TX beam 308 to transmit signals—e.g., data signals and/or RSs—towards the RRD 109. Typically, the relative positioning between the BS 101 and the RRD 109 can be comparably static.

Therefore, the DL TX beam 308 is comparably static. While FIG. 3 illustrates a line-of-sight communication, as a general rule, also non-line-of-sight communication would be possible.

The signals arrive at the RRD 109 at an input direction 661. The RRD 109 applies a spatial filter that defines an output direction 671 towards the UE 102. More specifically, a respective output beam 671A is defined, e.g., having a certain beam width etc. The spatial filter also defines the input direction 661 from the incident signals are accepted.

Due to UE mobility, it can be required from time to time to reconfigure another spatial filter at the RRD 109 to define another output direction. This is facilitated by an FMP, as described herein.

The beam management at the UE 102 to configure the appropriate DL RX beam or UL TX beam is out-of-scope of this disclosure; reference techniques are available.

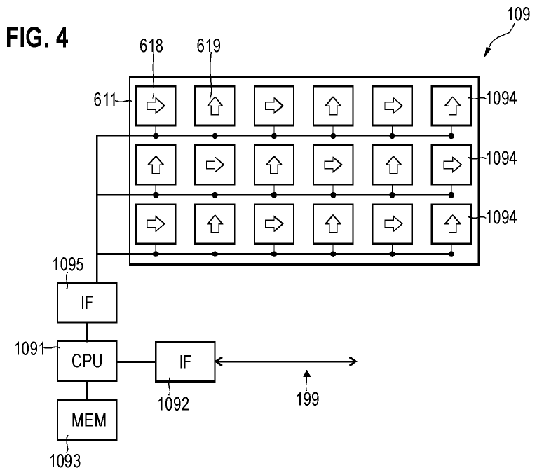

FIG. 4 illustrates aspects in connection with the RRD 109. The RRD 109 includes an array of polarized REs 1094—e.g., antennas or meta-material unit cells—each imposing a respective configurable phase shift when reflecting or re-transmitting or attenuating incident electromagnetic waves of a respective polarization 618, 619 (H-POL 618 and V-POL 619), i.e., the REs 1094 having H-POL 618 selectively act upon the H-POL component of incident signals.

The array of REs 1094 in the illustrated example is passive; i.e., the REs 1094 may not be able to change the amplitude of the electromagnetic waves. This array of REs 1094 forms a reflective surface 611. Typically, antennas can impose gradually varying phase shifts; while meta-material unit cells may, in some examples, be configured to provide only a set of phase shifts with a higher degree of quantization if compared to antennas, e.g., a either one of two phase shifts, e.g., such as +90° or −90° or 0° and +180° (“1-bit setting”).

Each RE 1094 can locally provide a respective phase shift, i.e., each RE 1094 may be individually configured.

The RRD 109 also includes a processor 1091 and the memory 1093. The processor 1091 can load program code from the memory 1093 and execute the program code.

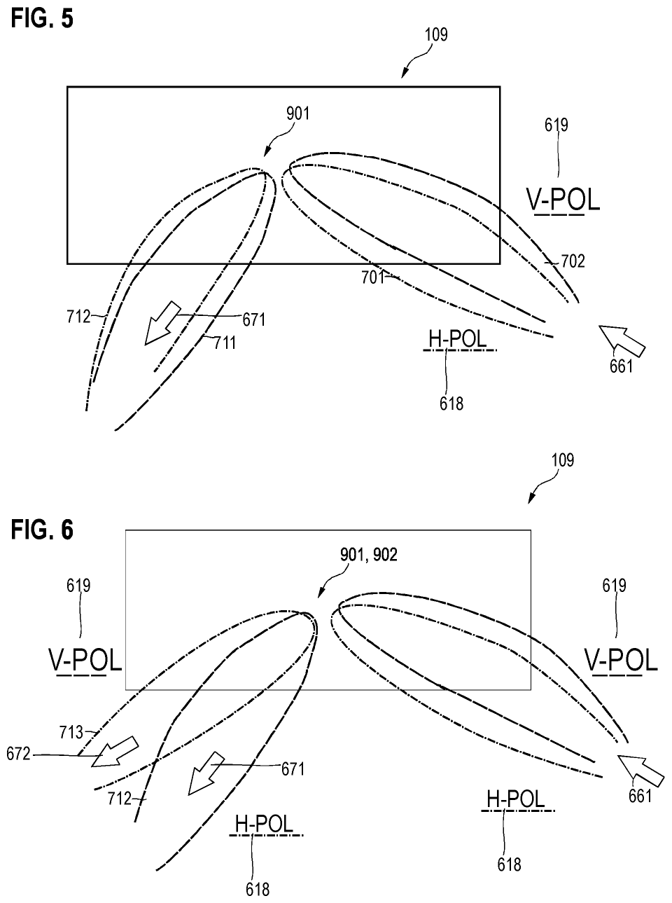

Upon loading and executing the program code, the processor 1091 can (re-)configure the reflective elements 1094 to implement a respective spatial filter, via a respective control interface 1095. There is also provided a communication interface 1092 via which the processor 1091 can communicate on a control link 199. Control messages or capability messages or other information can be exchanged between a node controlling the RRD 109 and the RRD 109. For instance, the control link 199 could be implemented using Bluetooth or Wi-Fi technology. The reconfiguration of REs 1094 defines respective spatial filters that are associated with spatial directions from which incident signals are accepted and spatial directions into which incoming electromagnetic waves are reflected, i.e., on a macroscopic level. Details with respect to the spatial filters are explained in FIG. 5 and FIG. 6.

FIG. 5 schematically illustrates aspects with respect to the RRD 109. Specifically, FIG. 5 schematically illustrates operation of a spatial filter 901. In the scenario of FIG. 5, signals are incident having polarizations 618, 619.

For each polarization 618, 619, the same spatial filter 901 is configured. The spatial filter 901 accepts the incident signals from the direction 661 and outputs the signals along the direction 671. Furthermore, the spatial filter 901 is associated with a certain input beam profile 701, 702, as well as respective output beam profiles 711 and 712.

As a general rule, by configuring another spatial filter—different from the spatial filter 901—it would be possible to change the input direction 661, the output direction 671, and/or one of the beam profiles 701, 702, 711, 712.

In the scenario of FIG. 5, the same spatial filter 901 is configured for the polarization 618 and the polarization 619. As a general rule, for different polarizations, different spatial filters could be configured in such a scenario as illustrated in FIG. 6.

FIG. 6 schematically illustrates aspects with respect to the RRD 109. Specifically, FIG. 6 schematically illustrates the operation of multiple spatial filters 901, 902, one for each one of the polarizations 618, 619.

Specifically, the spatial filter 902 acting upon the incident signals having the polarizations 618, accepts the incident signals from the direction 661 and having the beam profile 701 and outputs the signals along the direction 672 and having the beam profile 713.

The spatial filter 901 acting upon the incident signals having the polarization 619 has been explained in connection with FIG. 5.

As will be appreciated from FIG. 6, by using polarization-sensitive spatial filters, signals having different polarizations can be forwarded to different output directions 671, 672. Different beam profiles can be used to forward the signals.

This finding is exploited in examples disclosed herein to multiplex transmission of RSs and a data transmission including data signals.

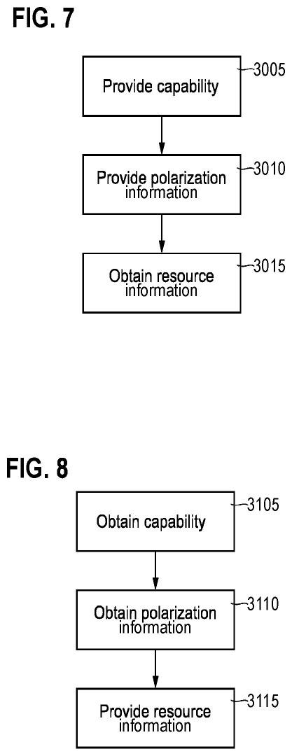

FIG. 7 is a flowchart of a method according to various examples. FIG. 7 could be executed by an RRD, e.g., by the RRD 109. More specifically, the method of FIG. 7 could be executed by the processor 1091, e.g., upon loading program code from the memory 1093.

The method of FIG. 7 schematically illustrates a configuration phase of an FMP.

At box 3005, the RRD provides a capability message to a node that controls the operation of the RRD. For example, the RRD could be controlled by a BS such as the BS 101. This can be via a control link (cf. FIG. 3, control link 199).

The capability message can be indicative of one or more capabilities of the RRD with respect to participating in an FMP. For example, the capability message could be indicative of the capability of the RRD to configure multiple spatial filters contemporaneously, the multiple spatial filters acting upon incident signals of different polarization. The capability could be indicated that the RRD is capable of applying different spatial filters to different incident signals, the different incident signals having different polarizations (cf. FIG. 6).

The capability could also pertain to a reconfiguration duration required to configure multiple spatial filters. More specifically, the reconfiguration duration could specify the time duration required to switch from an initial spatial filter to another spatial filter, e.g., by mechanically or electrically reconfiguring the reflective elements.

At box 3010, the RRD can provide polarization information to the node that controls the operation of the RRD, e.g., the BS. In other examples, the polarization information could also be provided to the RRD from the node controlling its operation.

The polarization information can be indicative of the polarizations of the polarization-sensitive REs. This means that the orientation of the polarization associated with respective spatial filters can be indicated. Thereby, nodes transmitting signals towards the RRD can set the polarization of these signals accordingly. A reference frame for H-POL and V-POL can be defined.

Sometimes, the polarization can be hardware defined and may not be changed. In other examples, it would also be possible that the RRD can change the polarization. In particular, in such cases, it would also be possible that the polarization information is provided to the RRD from the node controlling the RRD.

At box 3015, resource information is obtained, e.g., from a scheduler of a communication system or from the node that is controlling the RRD. The RRD could also transmit a respective request for certain resource information.

The resource information may be indicative of a timing of one or more RSs associated with the FMP. The timing could specify certain subframes of a sequence of subframes, which include RSs. Alternatively, another timing reference may be used. The timing could also be indicative of a start time and/or a stop time of channel sounding time gaps during which the one or more RSs are transmitted. A timing offset with respect to certain predefined events could be specified. A repetitive timing schedule could be indicated.

Alternatively or additionally to such timing, it would also be possible that the resource information is indicative of specific time-frequency resources allocated to the one or more RSs. The time-frequency resources can be specified in a time-frequency resource grid.

The time-frequency resources could be specified with respect to points in time that are defined by the timing. Time-frequency resources can be defined by subcarriers of an Orthogonal Frequency Division Multiplex modulation and by symbols of this modulation.

FIG. 8 is a flowchart of a method according to various examples. FIG. 8 could be executed by a communication node such as a BS. Specifically, the method could be executed by a node that is controlling an RRD. For example, the method of FIG. 8 could be executed by the processor 1011 of the BS 101, e.g., upon loading program code from the memory 1015. It would be possible that the method of FIG. 8 is executed by the processor 1021 of the UE 102 upon loading program code from the memory 1025.

The method of FIG. 8 schematically illustrates a configuration phase of an FMP.

The method of FIG. 8 is interrelated to the method of FIG. 7.

At box 3105, a capability message is obtained from the RRD. Box 3105 is interrelated to box 3005. Based on the capability of the RRD, it can be judged whether polarization multiplexing of data signals and RSs can be used in connection with the filter management procedure.

At box 3110, polarization information is obtained. The polarization information could alternatively also be provided to the RRD Box 3110 is interrelated with box 3010.

Based on the polarization information, the polarization of signals transmitted towards the RRD can be set. More specifically, a polarization of data signals and a polarization of RSs that are transmitted in a polarization-multiplexed manner can be set based on the polarization information.

At box 3115, resource information can be provided to the RRD. Box 3115 is interrelated to box 3015. Details with respect to the resource information have been explained in connection with box 3015.

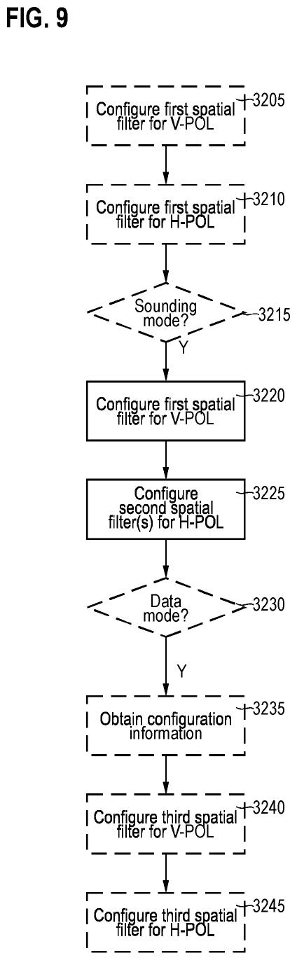

FIG. 9 is a flowchart of a method according to various examples. The method of FIG. 9 could be executed by an RRD, e.g., by the RRD 109. More specifically, the method of FIG. 9 could be executed by the processor 1091, e.g., upon loading program code from the memory 1093.

The method of FIG. 9 schematically illustrates an execution phase of an FMP. For example, the method of FIG. 9 may follow the method of FIG. 7.

Optional boxes are labeled with dashed lines.

At box 3205, a first spatial filter is configured for incident signals having a first polarization. Contemporaneously to box 3205, the same spatial filter is also configured for incident signals having a second polarization at box 3210. Thereby, incident data signals of a data transmission having either the first polarization or the second polarization can both be forwarded in the same output direction, towards a recipient node. Diversity or multiplexing of two data streams—having the first polarization or the second polarization—is facilitated.

At box 3215, it is checked whether a channel sounding mode is to be activated. In other examples, channel sounding may be permanently activated. Therefore, box 3205, box 3210 and box 3215 are optional.

Different trigger criteria for activating the channel sounding mode are conceivable. Some examples are described below. These trigger criteria could be used in isolation or cumulatively.

An example trigger criterion would include obtaining an activation message, e.g., from a scheduler of the communication system or a node controlling the RRD or more generally a node transmitting RSs. Thus, generally, the RRD can operate in the channel sounding mode in accordance with an activation message and/or a deactivation message that can be exchanged between the RRD and another node.

A further example trigger criterion includes a beginning of a channel sounding time gap. The timing of the channel sounding time gap can be predefined. For example, multiple repetitive channel sounding time gaps may be predefined. The respective timing could be indicated as resource information (cf. FIG. 7: box 3015; FIG. 8: box 3115). Then, the RRD can operate in the channel sounding mode during the repetitive channel sounding time gaps.

For example, upon detecting a trigger criterion, the RRD could provide a feedback signal to the node controlling the RRD. The feedback signal could indicate that the configuration of the RRD is stable, i.e., the RRD is not currently switching the spatial filter. Then, the channel sounding mode can be activated, without a need to require real-time synchronization with the RRD. The feedback signal could be indicative of a respective polarization for which the spatial filter is stable.

Upon activating the operation and the channel sounding mode, the RRD configures the first spatial filter for a first polarization, at box 3220. Thereby, incident data signals having the vertical polarization can be forwarded using the first spatial filter. The data transmission does not need to be interrupted.

At box 3225, contemporaneously to configuring the first spatial filter for the first polarization, one or more second spatial filters are configured to forward one or more RSs of the FMP using the second polarization into one or more second spatial output directions that are at least partly different to the first spatial output direction into which the data signals are forwarded using the first spatial filter of box 3220.

Specifically, multiple second spatial polarization filters can be swept, i.e., sequentially activated to probe different spatial paths. Thereby, UE mobility can be efficiently tracked. Here, also the first spatial output direction may be used, e.g., as a reference benchmark.

It would be possible that such sweeping is in accordance with the timing of the RSs that are transmitted. For example, in silent durations during which no RSs are transmitted, a reconfiguration from a first one of the multiple second spatial polarization filters to a second one of the multiple spatial polarization filters can be implemented. This enables efficient spectral usage. Overhead can be reduced by implementing the silent durations.

At box 3230, it is optionally checked whether the channel sounding mode is completed so that operating the RRD and the data mode is to commence. In the affirmative, the method proceeds with box 3235.

At box 3235, configuration information is obtained. The configuration could be selectively obtained in case a reconfiguration of spatial filters is required.

The configuration information is determined based on the one or more RSs that have been transmitted during the channel sounding mode and that have been forwarded using the one or more second spatial filters configured at box 3225. The configuration information can be specifically determined based on one or more receive properties of the RSs, e.g., phase shift and/or amplitude gain. Then, a third spatial filter can be configured for both polarizations at box 3240 and box 3245 and data signals can be forwarded using the third spatial filter. The third spatial filter is configured based on the configuration information.

The third spatial filter could be selected from the set of second spatial filters that are swept at box 3225. The best second spatial filter can be used as the third spatial filter.

In some scenarios, the configuration information may be explicitly indicative of the third spatial filter; in other examples, the third spatial filter may be inferred from the configuration information. The output direction to which incident signals are forwarded by the third spatial filter may be directed towards a recipient node, e.g., the UE.

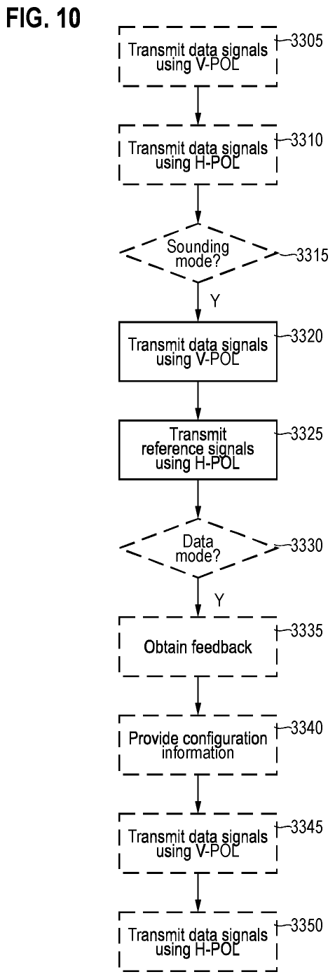

FIG. 10 is a flowchart of a method according to various examples. The method of FIG. 10 can be executed by a node of a communication system, e.g., by a BS. The method of FIG. 10 is interrelated with the method of FIG. 9. For example, the method of FIG. 10 could be executed by the BS 101, e.g., by the processor 1011 upon loading program code from the memory 1015. The method of FIG. 10 could also be executed by the UE 102, e.g., by the processor 1021 upon loading program code from the memory 1025.

The method of FIG. 10 schematically illustrates an execution phase of an FMP. For example, the method of FIG. 10 may follow the method of FIG. 8.

Optional boxes are labeled using dashed lines.

At box 3305 data signals of a data transmission associated with the FMP are transmitted using a first polarization. Contemporaneously to transmitting the data signals using the first polarization at box 3305, at box 3310, data signals are transmitted using a second polarization. A similar TX beam can be used for transmitting the data signals at box 3305 and the data signals at box 3310. Multiplexing or diversity could be used.

Box 3305 is associated with box 3205 in that the data signals transmitted using the first polarization at box 3305 a forwarded by the RRD using the respective first spatial filter configured for the first polarization at box 3205. Likewise, the data signals transmitted using the second polarization at box 3310 forwarded by the RRD using the same spatial filter at box 3210.

At box 3315, it is checked whether channel sounding mode is to be activated. One or more trigger criteria can be checked.

For example, a trigger criterion could be a feedback signal provided by the RRD. The feedback signal could indicate that the configuration of the RRD is stable, i.e., the RRD is not currently switching the spatial filter. Then, the channel sounding mode can be activated, without a need to require real-time synchronization with the RRD. The feedback signal could be indicative of a respective polarization for which the spatial filter is stable.

In the affirmative, at box 3320, data signals are continued to be transmitted using the first polarization at box 3320. For example, the same DL TX beam also used in box 3305 can be used in box 3320.

Then, RSs are transmitted using the second polarization at box 3325, i.e., polarization multiplexing of the data signals transmitted at box 3320 and the RSs transmitted at box 3325 can be implemented.

As a general rule, polarization multiplexing of the data signals and the reference signals does not require that the data signals and the reference signals are transmitted at the exact same time instance, i.e., are transmitted contemporaneously. Rather, it would be possible that the data signals and the reference signals are transmitted within the same predetermined time duration, e.g., a time slot of 0.5 milliseconds duration or a subprime of one millisecond duration to give just to examples, using different polarizations.

At box 3330 it is checked whether the channel sounding mode is completed. Box 3330 is thus interrelated with box 3230 of FIG. 9.

It would be possible to signal a bitmap. Entries of the bitmap could be indicative of a receive amplitude and/or received phase of a respective received reference signal. It would be possible that, where multiple reference signals are received, feedback for each one of the multiple received reference signals is provided. Alternatively, it would also be possible that feedback is only provided for the strongest or few strongest reference signals received.

At box 3335, feedback associated with the one or more RSs transmitted at box 3325 is obtained from a node monitoring for these RSs. The feedback could be indicative of one or more receive properties of the RSs.

There are various options available for implementing the feedback.

It would be possible that where multiple reference signals are received, feedback for each one of the multiple received reference signals is provided. Alternatively, it would also be possible that feedback is only provided for the strongest or few strongest reference signals received. For example, a point in time of the strongest received RS may be indicated. For example, an identity of the strongest received RS may be indicated. It would be possible to signal a bitmap. Entries of the bitmap could be indicative of a receive amplitude and/or received phase of a respective received reference signal. The feedback could be indicative of a relative amplitude and/or phase to a predefined reference value.

There can be a mapping between RSs transmitted and the respective second spatial filter used by the RRD to forward the RSs (cf. FIG. 9: box 3225). The mapping could be based on points in time at which the RSs are transmitted and at which the second spatial filters are reconfigured during a respective sweep. The mapping could also be based on identities embedded into the RSs. The mapping could be determined based on the resource information (cf. FIG. 7: box 3015; FIG. 8: box 3115). Using such mapping, it is possible to conclude which second spatial filter of multiple swept second spatial filters provides for a good communication between the two nodes.

At box 3340, configuration information is provided to the RRD for configuring a spatial polarization filter for one or more further data signals that are transmitted at box 3345 and box 3350 of the data transmission. For example, the third spatial filter of box 3240 and box 3245 can thereby be configured. The configuration information is determined based on the feedback obtained at box 3335. A mapping, as explained above, may be used to determine the configuration information.

As will be appreciated in the scenario of FIG. 10, the one or more RSs are selectively transmitted when the RRD operates in the channel sounding mode associated with the FMP, i.e., they are not transmitted when the RRD operates in the data mode. Trigger criteria for activating the channel sounding mode—e.g., a predefined timing, or an activation/deactivation message—have been discussed above. In other scenarios, it would also be possible that the one or more RSs are continuously transmitted.

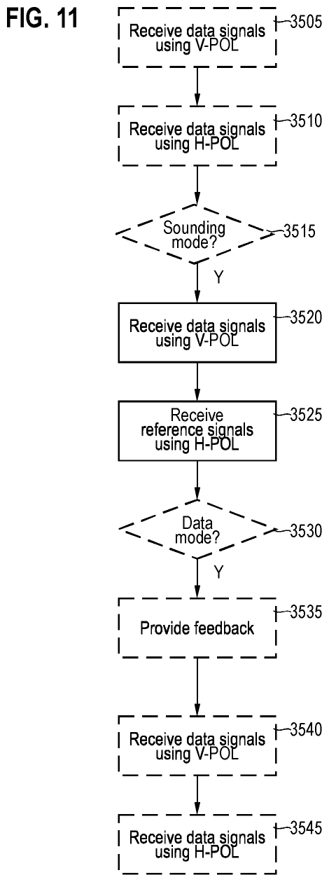

FIG. 11 is a flowchart of a method according to various examples. The method of FIG. 11 could be executed by a node of a communication system. For example, the method of FIG. 11 could be executed by the UE 102, e.g., by the processor 1021 upon loading and executing program code from the memory 1025. It would also be possible that the method of FIG. 11 is executed by a BS such as the BS 101, e.g., executed by the processor 1011 upon loading and executing program code from the memory 1015.

The method of FIG. 11 schematically illustrates an execution phase of an FMP. The method of FIG. 11 is interrelated with the method of FIG. 9 and the method of FIG. 10.

Optional boxes are labeled using dashed lines.

At box 3505, data signals of a data transmission are received, the data signals having a first polarization.

At box 3510, data signals of the data transmission are received, the data signals having a second polarization.

The data signals of box 3505 and box 3510 are transmitted and received using polarization multiplexing.

Box 3505 and box 3510 are thus interrelated with box 3305 and box 3310.

At box 3515, it is checked whether the channel sounding mode is to be activated. Similar trigger criteria as already discussed above at box 3215 or box 3315 also apply to box 3515.

At box 3520, data signals of the data transmission are received using the first polarization.

At box 3525, the node receives RSs having the second polarization.

Once the data mode commences, at box 3530, feedback on one or more receive properties of the RSs as determined from box 3525 can be provided. Box 3535 is thus interrelated to box 3335.

Feedback could be conditionally provided in case the feedback has changed compared to another feedback provided earlier.

Then, at box 3540 and box 3545, data signals of the data transmission are received using the first and second polarizations, respectively. The data signals can be forwarded by the RRD using another spatial filter that has been reconfigured based on the feedback provided at box 3535, as discussed above in connection with FIG. 9: box 3240 and box 3245.

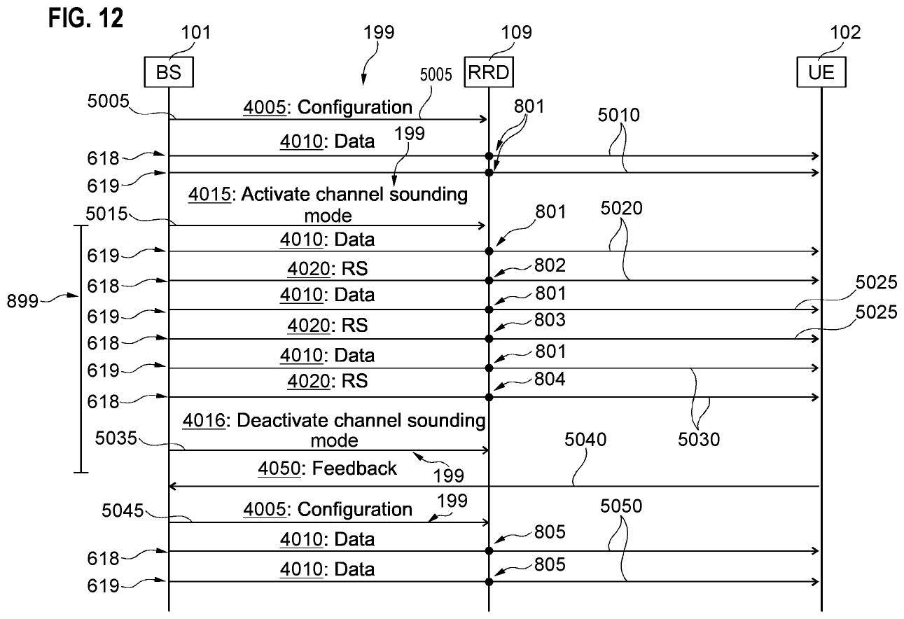

FIG. 12 is a signaling diagram of communication between the BS 101 and the UE 102 via the RRD 109.

At 5005, configuration information 4005 is provided by the BS 101 to the RRD 109, e.g., on a respective control link 199. The configuration information 4005 is indicative of a spatial filter 801 to be configured at the RRD 109.

At 5010, the BS 101 transmits data signals 4010 of the data transmission. At this point, the RRD 109 is configured with a first spatial filter 801. The data signals 4010 are transmitted using both the vertical polarization as well as the horizontal polarization 618-619. Thereby, the diversity and/or polarization multiplexing can be implemented.

Then, the channel sounding mode is activated, during a respective channel sounding time gap 899, the BS 101 transmits—in addition to the data signals encoding data of the data transmission—also RSs 4020.

In the illustrated example, an activate message 4015 is provided by the BS 101 to the RRD at 5015 that activates the channel sounding mode. This activation message 4015 is optional.

At 5020, a data signal 4010 and the RS 4020 are transmitted using polarization multiplexing by the BS 101. The data signal 4010 is transmitted using the vertical polarization 619 and the RSs transmitted using the horizontal polarization 618.

At 5025, a data signal 4010 and a RS 4020 are transmitted by the BS 101 using polarization multiplexing using the vertical polarization 619 for the data signal 4010 and the horizontal polarization 618 for the RS 4020.

At 5030, a data signal 4010 and the RS 4020 are transmitted by the BS 101 using polarization multiplexing using the vertical polarization 619 for the data signal 4010 and the horizontal polarization 618 for the RS 4020.

The RRD 109 configures—using a filter sweep—multiple second spatial filters 802-804 (different than the first spatial filter 801) for forwarding the RSs 4020 transmitted at 5020, 5025, and 5030. The first spatial filter 801 is continuously used for forwarding the data signals 4010 at 5020, 5025, and 5030.

It is then possible to deactivate the channel sounding mode by the BS 101 providing a respective deactivation message 4016 at 5035 to the RRD 109.

The UE 102 can provide a feedback 4050 at 5040 to the BS 101 and the BS 101 can provide a further instance of the configuration message 4005 to the RRD 109 at 5045, thereby configuring the third spatial filter 80. The third spatial filter 805 can be the same as one of the second spatial filters 802-804. The third spatial filter 805 is selected because it shows the best properties of all tested second spatial filters 802, 803, 804.

The third spatial filter 805 is then used at 5050 for forwarding data signals 4010 transmitted by the BS 101 using the vertical polarization 619 and the horizontal polarization 618, respectively.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, various scenarios have been described with respect to H-POL and V-POL. Here, arbitrary definitions of the horizontal and vertical directions are possible. Further, instead of using linear polarizations, it is possible to use circular polarizations, e.g., left circular polarization and right circular polarization.

For further illustration, various examples have been described with respect to an implementation of an RRD using REs. However, an RRD can also be implemented using transmissive elements that can impose a variable attenuation.

For still further illustration, various examples have been described according to which data signals and reference signals are transmitted using polarization multiplexing and respective spatial filters are contemporaneously configured at the RRD (in respective data and channel sounding modes). Instead of using polarization multiplexing for data signals and reference signals, it would also be possible to use polarization multiplexing for multiple types of RSs; different spatial filters can be configured for the different types of RSs. For instance, these different types of reference signals may be used for different purposes. For instance, a first type of RSs may pertain to positioning of a node, e.g., using time difference of arrival measurements or angle of arrival measurements based on the positioning RSs in a positioning mode; while a second type of RSs may be used for channel sounding, e.g., CSI-RS.

1. A method of operating a reconfigurable relaying device (RRD) the RRD being reconfigurable to provide multiple spatial filters, each one of the multiple spatial filters being associated with a respective input spatial direction from which incident signals are accepted and with a respective output spatial direction into which the incident signals are output, the RRD supporting communication between a first communication node (CN) and a second CN, the method comprising:
configuring a first spatial filter to forward one or more first signals using a first polarization into a first output spatial direction, and
contemporaneously to said configuring the first spatial filter: configuring one or more second spatial filters to forward one or more second signals using a second polarization into one or more second output spatial directions,
wherein the one or more second signals comprise one or more reference signals,
wherein the one or more second output spatial directions are at least partially different than the first output spatial direction.

2. The method of claim 1,
wherein the one or more second spatial filters comprises multiple second spatial filters that are swept.

3. The method of claim 2,
wherein the multiple second spatial filters are swept in accordance with a timing of the one or more reference signals.

4. The method of claim 1, further comprising:
obtaining configuration information from the first CN determined based on the one or more reference signals, and
configuring a third spatial filter to reflect one or more further signals based on the configuration information.

5. The method of claim 1,
wherein the one or more second spatial filters are selectively configured when the RRD operates in a channel sounding mode.

6. The method of claim 5,
wherein the RRD operates in the channel sounding mode during repetitive channel sounding time gaps.

7. The method of claim 5, further comprising:
when not operating in the channel sounding mode: configuring a third spatial filter to reflect one or more third signals using the second polarization.

8. A method of operating a first communication node (CN) the first CN communicating with a second CN via a reconfigurable relaying device (RRD) the RRD being reconfigurable to provide multiple spatial filters, each one of the multiple spatial filters being associated with a respective input spatial direction from which incident signals are accepted and with a respective output spatial direction into which the incident signals are output, the method comprising:
transmitting, towards the RRD, one or more first signals using a first polarization, and
transmitting, towards the RRD, one or more second signals using a second polarization different than the first polarization,
wherein the one or more second signals comprise one or more reference signals,
wherein the one or more first signals and the one or more second signals are transmitted using polarization multiplexing.

9. The method of claim 8, further comprising:
obtaining a feedback associated with the one or more reference signals from the second CN, and
based on the feedback, providing configuration information to the RRD for configuring at least one spatial filter of the multiple spatial filters for one or more further signals.

10. The method of claim 8, further comprising:
communicating polarization information between the first CN and the RRD, the polarization information being indicative of the first polarization and the second polarization.

11. The method of claim 8, further comprising:
communicating resource information between the first CN and the RRD, the resource information being indicative a timing of the one or more reference signals and/or of time-frequency resources allocated to the one or more reference signals.

12. The method of claim 8,
wherein the one or more reference signals are selectively transmitted when the RRD operates in a channel sounding mode.

13. The method of claim 12, further comprising:
wherein the RRD operates in the channel sounding mode in accordance with at least one of a predefined timing, an activation message communicated between the RRD and the first CN, or a deactivation message communicated between the RRD and the first CN.

14. The method of claim 8, further comprising:
communicating, from the RRD to the first CN, a capability message, the capability message being indicative of at least one of a capability of the RRD to configure the one or more second spatial filters contemporaneously to said configuring the first spatial filter, or a reconfiguration duration for reconfiguring the multiple spatial filters.

15. A method of operating a second communication node (CN) the second CN communicating with a first CN via a reconfigurable relaying device RRD the RRD being reconfigurable to provide multiple spatial filters, each one of the multiple spatial filters being associated with a respective input spatial direction from which incident signals are accepted and with a respective output spatial direction into which the incident signals are output, the method comprising:
receiving, via the RRD, one or more first signals using a first polarization,
receiving, via the RRD, one or more second signals using a second polarization different than the first polarization,
wherein the one or more second signals comprise one or more reference signals,
wherein the one or more first signals and the one or more second signals are received using polarization multiplexing.

16-21. (canceled)
